(19) United States
(12) Patent Application Publication
(10) Pub. No.: US 2026/0299735 A1
(43) Pub. Date: Oct. 1, 2026

(54) TOUCH DETECTION DEVICE AND TOUCH DETECTION METHOD THEREOF

(71) Applicant: Novatek Microelectronics Corp., Hsinchu (TW)

(72) Inventors: Hsiang-Cheng Yu, Hsinchu County (TW); Chin-Lin Lee, Hsinchu City (TW); Pao Hung Lin, Hsinchu County (TW)

(73) Assignee: Novatek Microelectronics Corp., Hsinchu (TW)

(21) Appl. No.: 19/096,682

(22) Filed: Mar. 31, 2025

(51) Int. Cl. G06F 3/042; H02S 30/10; H02S 50/00

(52) U.S. Cl. CPC G06F 3/0421; H02S 30/10; H02S 50/00; G06F 3/04186; G06F 3/044; G06F 3/0488

(57) ABSTRACT

A touch detection device includes a control circuit. The control circuit is configured to: detect whether at least one zone of a touch panel is touched according to a plurality of touch sensing values corresponding to a plurality of touch sensing electrodes of the touch panel; and, to each of the at least one touched zone, determine the touched zone is caused by a finger touch or a liquid touch according a solar energy conversion efficiency value, wherein the solar energy conversion efficiency value represents how much solar energy is converted to electricity.

### BACKGROUND

### Field of the Invention

The invention relates to a touch detection device, touch detection method and an electronic device, and more particularly, to the touch detection device, touch detection method and the electronic device which can increase an accuracy of touch position reporting.

### Description of Related Art

In conventional art, handheld electronic devices are widely used currently. The handheld electronic device always provides a touch panel for providing a human computer interaction interface. In practical application, water may drop on the touch panel and the touch detection device may mis-judge the touched zone caused by the water to be a finger touched zone. Such as that, the touch detection device may provide wrong touch position information to a host, and an unexpected operation may be performed by the host.

### SUMMARY

The invention provides a touch detection device, touch detection method and an electronic device which can prevent from false position reporting caused by water or transparent liquid.

According to an embodiment of the invention, the touch detection device includes a control circuit. The control circuit is configured to: detect whether at least one zone of a touch panel is touched according to a plurality of touch sensing values corresponding to a plurality of touch sensing electrodes of the touch panel; and, to each of the at least one touched zone, determine the touched zone is caused by a finger touch or a liquid touch according a solar energy conversion efficiency value, wherein the solar energy conversion efficiency value represents how much solar energy is converted to electricity.

According to another embodiment of the invention, the touch detection method includes: detecting whether at least one zone of a touch panel is touched according to a plurality of touch sensing values corresponding to a plurality of touch sensing electrodes of a touch panel; and, to each of the at least one touched zone, determining the touched zone is caused by a finger touch or a liquid touch according a solar energy conversion efficiency value, wherein the solar energy conversion efficiency value represents how much the solar energy is converted to electricity.

According to another embodiment of the invention, the electronic device includes a solar panel, a power management integrated circuit, a touch panel, a touch sensing integrated circuit and a host processor. The solar panel is used for converting solar energy to the electricity. The power management integrated circuit is coupled to the solar panel, configured to receive the electricity converted from the solar energy and generates a solar energy conversion efficiency value representing how much the solar energy is converted to the electricity. The touch panel includes a plurality of touch sensing electrodes. The touch sensing integrated circuit is coupled to the touch panel and configured to obtain a plurality of touch sensing values corresponding to the plurality of touch sensing electrodes. Either the touch sensing integrated circuit or the host processor includes a control circuit, and the control circuit is configured to: detect whether at least one zone of the touch panel is touched according to the plurality of touch sensing values corresponding to the plurality of touch sensing electrodes; and, to each of the at least one touched zone, determine the touched zone is caused by a finger touch or a liquid touch according to the solar energy conversion efficiency value.

To sum up, the touch detection device of present disclosure detects whether at least one zone of a touch panel is touched by a finger or not by determining a solar energy conversion efficiency value of the touched zone, wherein the solar energy conversion efficiency value represents how much solar energy is converted to electricity. Such as that, touch sensing values obtained from the touch panel caused by water or transparent liquid can be ignored, and false position reporting caused by water or transparent liquid can be prevented.

To make the above features and advantages of the invention more comprehensible, embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic diagram of a touch detection device according to an embodiment of present disclosure

FIG. 2A to FIG. 2C illustrate schematic diagrams of touch sensing operation of a touch detection device according to an embodiment of present disclosure.

FIG. 3A illustrates a flow chart of a touch detection operation of a touch detection device according to an embodiment of present disclosure.

FIG. 3B illustrates detail operation of the step 340′ which is an alternative to the step S340 of FIG. 3A.

FIG. 4 illustrates a flow chart of a touch detection operation of a touch detection device according to another embodiment of present disclosure.

FIG. 5 illustrates a flow chart of a touch detection operation of a touch detection device according to another embodiment of present disclosure.

FIG. 6 illustrates an electronic device according to embodiment of present disclosure.

FIG. 7A to FIG. 7J respectively illustrate a plurality of exploded views of electronic device according to a plurality embodiment of present disclosure.

FIG. 8 illustrates a flow chart of a touch detection method according to an embodiment of present disclosure.

### DESCRIPTION OF EMBODIMENTS

The terms “couple (or connect)” throughout the specification (including the claims) of this application are used broadly and encompass direct and indirect connection or coupling means. For instance, if the disclosure describes a first apparatus being coupled (or connected) to a second apparatus, then it should be interpreted that the first apparatus can be directly connected to the second apparatus, or the first apparatus can be indirectly connected to the second apparatus through other devices or by a certain coupling means. In addition, terms such as “first” and “second” mentioned throughout the specification (including the claims) of this application are only for naming the names of the elements or distinguishing different embodiments or scopes and are not intended to limit the upper limit or the lower limit of the number of the elements not intended to limit sequences of the elements. Moreover, elements/components/steps with same reference numerals represent same or similar parts in the drawings and embodiments. Elements/components/notations with the same reference numerals in different embodiments may be referenced to the related description.

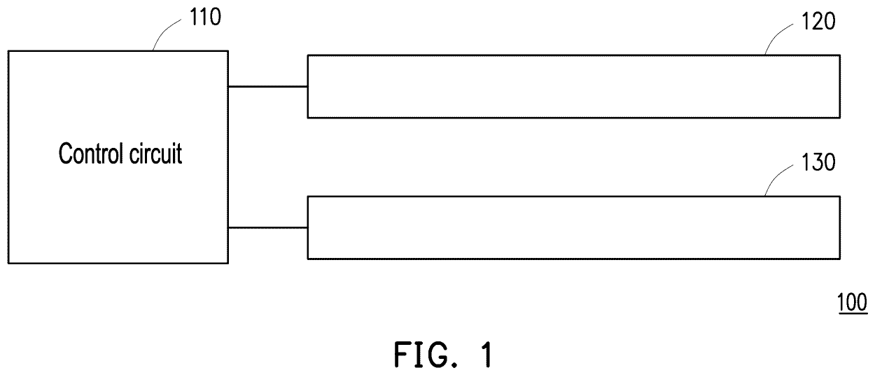

Please refer to FIG. 1, which illustrates a schematic diagram of a touch detection device according to an embodiment of present disclosure. The touch detection device 100 includes a control circuit 110. The control circuit 110 is coupled to a touch panel 120 and a solar panel 130. In this embodiment, the touch panel 120 and the solar panel 130 may be disposed overlapped. The touch panel 120 is configured to detect a touched zone caused by a touch object, and report position information of the touched zone. The solar panel 130 is configured to convert a sunlight to an electric energy, and provides the electric energy to be an operation power to an electronic device.

The control circuit 110 is configured to detect whether at least one zone of a touch panel is touched according to a plurality of touch sensing values corresponding to a plurality of touch sensing electrodes of the touch panel 120. The control circuit 110 is further configured to, to each of the at least one touched zone, determine the touched zone is caused by a finger touch or a liquid touch according a solar energy conversion efficiency value, wherein the solar energy conversion efficiency value represents how much solar energy is converted to electricity. In different embodiments of the present disclosure, the touch detection device may be a device including the control circuit configured to perform the step of detecting the touched zone and the step of determining the touched zone is caused by a finger touch or a liquid touch, no matter the touch sensing values are generated by the touch detection device itself or received from the other device who generates the touch sensing values. Therefore, the touch detection device may be a touch control integrated circuit, a touch and display driver integrated circuit (TDDI), or a central processor such as an application processor (AP) of a mobile device such as a smart watch or a smart phone.

In this embodiment, the touch panel 120 may include a plurality of touch sensing electrodes, and the plurality of touch sensing electrodes may be uniformly or dis-uniformly arranged on the display panel. When a touch object touches the touch panel 120, no matter where the touched position is, different capacitance variations may be induced by the touch event and corresponding touch sensing signals are transmitted from the touch sensing electrodes to the control circuit 110, and the control circuit 100 generates touch sensing values according to the touch sensing signals.

In this embodiment, if the touched zone is touched by a finger of user, sunlight to the touched zone may be covered by the finger, and such as that, the solar energy conversion efficiency value of an area of the solar panel 130 corresponding to the touched zone may be reduced. On the other hand, if the touched zone is covered by water or transparent liquid, sunlight can deliver to the area of the solar panel 130 corresponding to the touched zone and does not be blocked by the water or transparent liquid, and such as that, the solar energy conversion efficiency value of an area of the solar panel 130 corresponding to the touched zone may be kept almost same as that of an area of the solar panel 130 corresponding to the untouched part of the touch panel 120.

That is, the control circuit 110 of the touch detection device 100 may determine each of the touched zones is caused by a finger touch or a liquid touch according to a solar energy conversion efficiency value corresponding to each of the touched zone, wherein the solar energy conversion efficiency value represents how much solar energy is converted to electricity. Such as that, the touched zones caused by the liquid touch can be excluded, and the control circuit 110 may report position of the touched zone caused by the finger touch precisely.

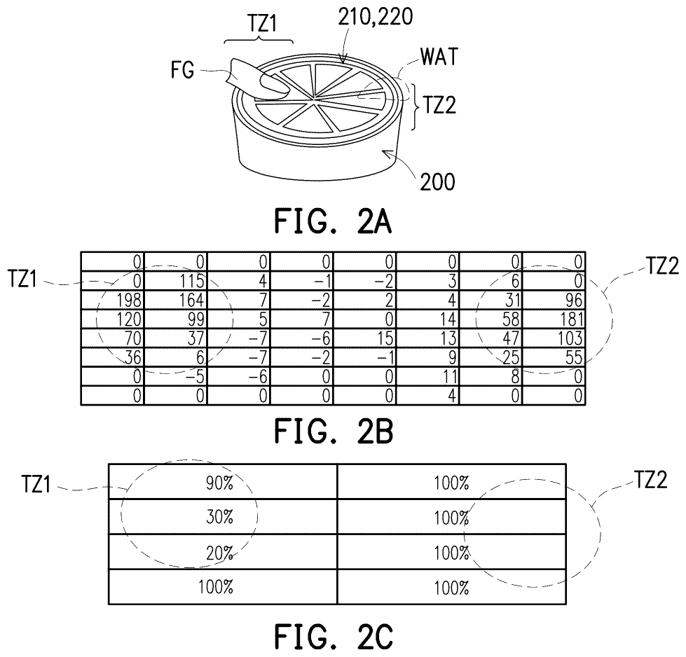

Please refer to FIG. 2A to FIG. 2C, wherein illustrate schematic diagrams of touch sensing operation of a touch detection device according to an embodiment of present disclosure. In FIG. 2A, a touch panel 210 and a solar panel 220 (divided by sectors as an example) are overlapped disposed on a surface of a touch detection device 200. During a touch detection operation, a finger FG and a water drop WAT are disposed on the surface of the touch detection device 200. The finger FG leads to a finger touch on the touch detection device 200 to form a touched zone TZ1, which is determined after touch sensing signals corresponding to the touch sensing electrodes are processed by a control circuit (such as 110 of FIG. 1) of the touch detection device, and the water drop WAT leads to a liquid touch on the touch detection device 200 to form a touched zone TZ2, which is determined after the touch sensing signals corresponding to the touch sensing electrodes are processed by the control circuit. In FIG. 2B, the touch panel 210 has a plurality of touch sensing electrodes, and from a plurality of touch sensing values generated based on the touch sensing signals corresponding to the touch sensing electrodes, the touched zones TZ1 and TZ are distinguished. For example, a zone which includes the touch sensing electrodes corresponding to touch sensing values larger than a threshold is recognized as a touched zone.

In FIG. 2C, the solar panel 220 (divided by eight sectors as the example of FIG. 2A) may report a plurality of solar energy conversion efficiency values corresponding to a plurality of sub-regions of the solar panel 220. In this embodiment, the touched zone TZ1 is covered by the finger FG, and the solar energy conversion efficiency values corresponding to the touched zone TZ1 are smaller than 100%. On the other hand, the touched zone TZ2 is covered by the water drop WAT, and the solar energy conversion efficiency values corresponding to the touched zone TZ1 may be kept on 100%. Such as that, the control circuit may determine that the touched zone TZ1 may be touched by the finger FG and the touched zone TZ2 may be touched by water or transparent liquid, and the control circuit may report position of the touched zone TZ1, such as a center-of-mass coordinate of the touched zone TZ1.

In detail, the control circuit of the touch detection device 200 may preset an energy conversion efficiency threshold. Furthermore, the control circuit may determine the touched zone TZ1 is caused by the finger touch in response to that the control circuit determines the touched zone TZ1 is in a range of a part of the solar panel 220 which has the solar energy conversion efficiency value less than the energy conversion efficiency threshold. Moreover, the control circuit may determine the touched zone TZ2 is caused by the liquid touch in response to that the control circuit determines the touched zone TZ2 is not in a range of a part of the solar panel which has the solar energy conversion efficiency value less than the energy conversion efficiency threshold. In this embodiment, the energy conversion efficiency threshold may be 95%.

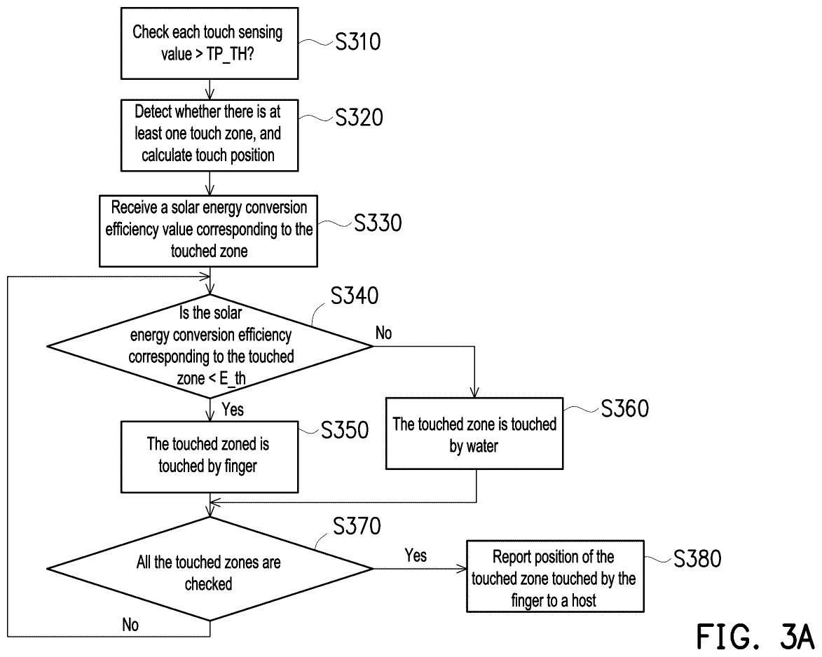

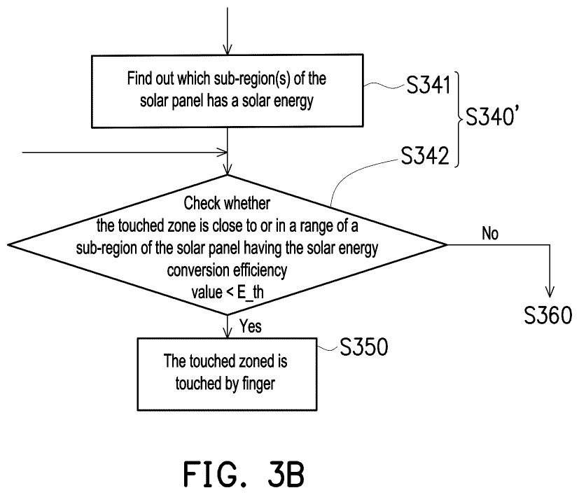

Please refer to FIG. 3A, which illustrates a flow chart of a touch detection operation of a touch detection device according to an embodiment of present disclosure. In step S310, the control circuit of a touch detect device may compare each of the touch sensing values with a touch threshold TP_TH to determine whether each of the touch sensing values is larger than the touch threshold TP_TH or not. In step S320, the control circuit may detect whether there is at least one touched zone according to comparison result of the step S310, and the control circuit may calculate a position of each of the touched zone, where the position may be coordinates of each touched zone. In detail, if there is at least one of the touch sensing values larger than the touch threshold TP_TH found, the control circuit may set the corresponding zone of the touch panel to the touched zone.

In step S340, the control circuit may receive a solar energy conversion efficiency value corresponding to each touched zone. The control circuit may compare the solar energy conversion efficiency value with a solar energy conversion efficiency threshold E_th to determine whether the solar energy conversion efficiency value of each touched zone is smaller than the solar energy conversion efficiency threshold E_th or not (step S340). If the solar energy conversion efficiency value of each touched zone is smaller than the solar energy conversion efficiency threshold E_th, step S350 can be executed, and if the solar energy conversion efficiency value of each touched zone is not smaller than the solar energy conversion efficiency threshold E_th, step S360 can be executed. In the step S350, the control circuit can determine the touched zone is touched by a finger. In the step S360, the control circuit can determine the touched zone may be touched by water or transparent liquid.

In step S370, the control circuit may judge whether all the touched zones are checked, if a judge result of the step S370 is Yes, the control circuit may perform step S380 to report position of each touched zone touched by the finger to a host, such as that a touch and display driver integrated circuit (TDDI) reports the position of each touched zone to an application processor. On the other hand, if the judge result of the step S370 is No, the control circuit may perform the step S340 again to check another touched zone.

Please refer to FIG. 3B, which illustrates detail operation of the step 340′ which is an alternative to the step S340 of FIG. 3A. The step S340′ may be performed by steps S341 and S342. In the step S341, the control circuit may find out which sub-region(s) of the solar panel has a solar energy conversion efficiency value smaller than the solar energy conversion efficiency threshold E_th, and in the step S342, the control circuit may check whether the touched zone is close to or in a range of a sub-region of the solar panel having the solar energy conversion efficiency value smaller than the solar energy conversion efficiency threshold E_th. If the determining result of the step S342 is Yes, the step S350 may be performed, and if the determining result of the step S342 is No, the step S360 may be performed.

In this embodiment illustrated in FIG. 3B, the control circuit determines the touched zone is caused by the liquid touch in response to that the control circuit determines the touched zone is not in a range of a part (i.e., one or more sub-regions) of the solar panel which has the solar energy conversion efficiency value smaller than a first energy conversion efficiency threshold. Furthermore, the control circuit may determine the touched zone is caused by the finger touch in response to that the control circuit determines that the touched zone is in a range of a part (i.e., one or more sub-regions) of the solar panel which has the solar energy conversion efficiency value smaller than a second energy conversion efficiency threshold. The first energy conversion efficiency threshold and the second energy conversion efficiency threshold may be same or different.

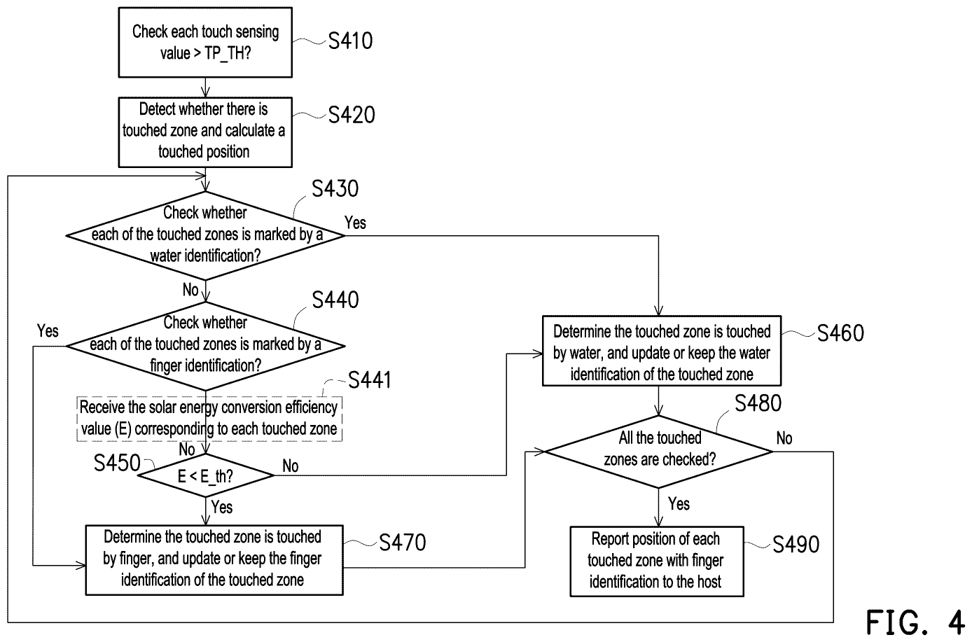

Please refer to FIG. 4, which illustrates a flow chart of a touch detection operation of a touch detection device according to another embodiment of present disclosure. In this embodiment, there is no divided sub-region on the solar panel. In step S410, the control circuit of the touch detection device may compare each of the touch sensing values with a touch threshold TP_TH to determine whether each of the touch sensing values is larger than the touch threshold TP_TH or not. In step S420, the control circuit may detect whether there is at least one touched zone according to comparison result of the step S410, and the control circuit may calculate a position of each of the touched zone, where the position may be coordinates of each touched zone.

In step S430, the control circuit may check whether each of the touched zones is marked by a water identification (ID) or not. In this embodiment, the water ID is an auxiliary information and is used to indicate the corresponding touched zone is covered by water or transparent liquid in the previous touch sensing frame period. If the check result in the step S430 is No, step S440 can be performed, and if the check result in the step S430 is Yes, step S460 can be performed.

In the step S440, the control circuit may check whether each of the touched zones is marked by a finger identification (ID) or not. In this embodiment, the finger ID is another auxiliary information and is used to indicate the corresponding touched zone is touched by finger in the previous touch sensing frame period. If the check result of the step S440 is Yes, step S470 can be performed, and if the check result of the step S440 is No, steps S441 and S450 can be performed in sequential.

In the step S441, the control circuit may receive the solar energy conversion efficiency value (E) corresponding to each touched zone. Since the solar panel is not divided into sub-regions in this embodiment, such as that, the solar energy conversion efficiency value (E) is the solar energy conversion efficiency value of the entire solar panel. It is noted that, how much earlier the control circuit receives the solar energy conversion efficiency value E which is measured in a touch sensing frame period is not limited, as long as the control circuit can compare the solar energy conversion efficiency value E with the energy conversion efficiency threshold E_th in time.

In the step S450, the control circuit may compare the solar energy conversion efficiency value E with an energy conversion efficiency threshold E_th to determine whether the solar energy conversion efficiency value E is smaller than the energy conversion efficiency threshold E_th or not. If the comparison result of the step S450 is Yes, step S470 can be performed, and if the comparison result of the step S450 is No, the step S460 can be performed.

In the step S460, the control circuit determines the touched zone is touched by water, and update (if the step previous to S460 is S450) or keep (if the step previous to S460 is S430) the water ID of the touched zone. If the touched zone is not marked by the water ID previously, the control circuit may update the touched zone to be marked by the water ID in the step S460. If the touched zone is marked by the water ID in the previous touch sensing frame period, the control circuit may keep the water ID of the touched zone.

In step S470, the control circuit may determine the touched zone is touched by finger, and update (if the step previous to S470 is S450) or keep (if the step previous to S470 is S440) the finger ID of the touched zone. If the touched zone is not marked by the finger ID previously, the control circuit may update the touched zone to be marked by the finger ID in the step S470. If the touched zone is marked by the finger ID in the previous touch sensing frame period, the control circuit may keep the finger ID of the touched zone.

In step S480, the control circuit may judge whether all the touched zone are checked or not. If all the touched zones have been checked, the control circuit may perform step S490; if not all the touched zones have been checked, the control circuit may go back to the step S430 to check next one touched zone.

In the step S490, the control circuit may report position of each touched zone with finger ID to the host. In this embodiment, the position of each touched zone may be coordinates of each of the touched zones.

In this embodiment, the control circuit determines the touched zone is caused by the finger touch in response to that the control circuit detects the presence of the auxiliary information (the finger ID), or determines the touched zone is caused by the finger touch in response to that the control circuit detects the solar energy conversion efficiency value of the entire solar panel is less than the solar energy conversion efficiency threshold E_th even though the control circuit also detects the absence of the finger ID.

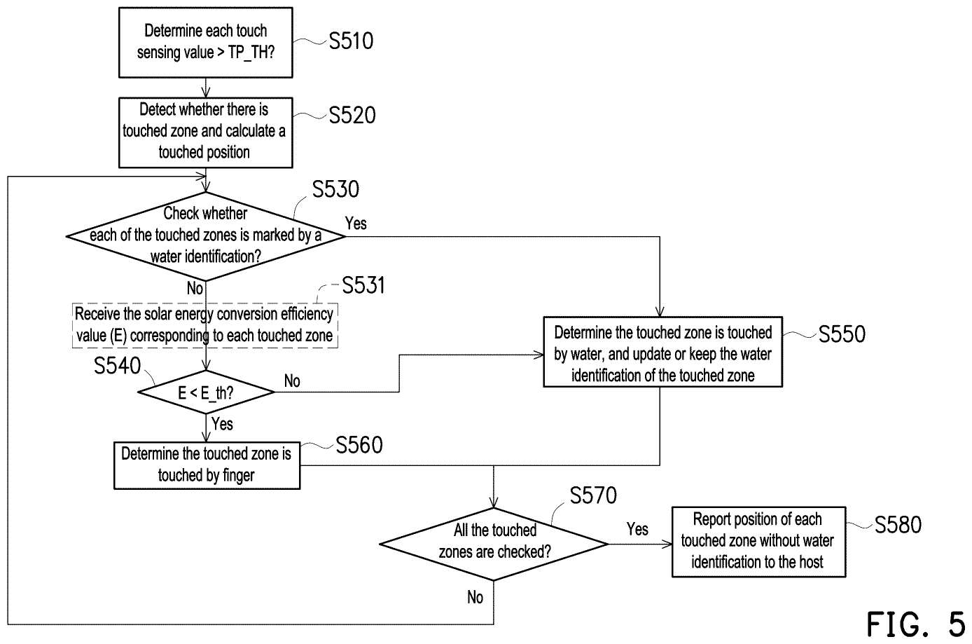

Please refer to FIG. 5, which illustrates a flow chart of a touch detection operation of a touch detection device according to another embodiment of present disclosure. In this embodiment, there is no sub-region on the solar panel. In step S510, the control circuit of the touch detection device may compare each of the touch sensing values with a touch threshold TP_TH to determine whether each of the touch sensing values is larger than the touch threshold TP_TH or not. In step S520, the control circuit may detect whether there is at least one touched zone according to comparison result of the step S510, and the control circuit may calculate a position of each of the touched zone, where the position may be coordinates of each touched zone.

In step S530, the control circuit checks whether each of the touched zones is marked by a water identification or not. If the check result is Yes, the control circuit may perform step S550; and if the check result is No, the control circuit may perform step S531. In the step S531, the control circuit receive the solar energy conversion efficiency value (E) corresponding to each touched zone. In this embodiment, since the solar panel is not divided into sub-regions, the solar energy conversion efficiency value E is solar energy conversion efficiency value of entire solar panel.

In step S540 the control circuit may compare the solar energy conversion efficiency value E with the solar energy conversion efficiency threshold E_th to determine whether the solar energy conversion efficiency value E is smaller than the solar energy conversion efficiency threshold E_th or not. If the comparison result of the step S540 is Yes, the control circuit may perform step S560; and if the comparison result of the step S540 is No, the control circuit may perform step S550.

In the step S550, the control circuit may determine the touched zone is touched by water, and update or keep the water identification (ID) of the touched zone. Since in the step S530 the control circuit has checked whether the touched zone is marked with the water ID or not in a previous touch sensing frame period, in the step S550 the control circuit may update the touched zone to be marked with the water ID if the touched zone is not marked with the water ID in the previous touch sensing frame period; or, in the step S550 the control circuit keeps the water ID on the touched zone unchanged if the touched zone is marked with the water ID in the previous touch sensing frame period.

In the step S560, the control circuit determines the touched zone is touched by finger when the solar energy conversion efficiency value E being smaller than the solar energy conversion efficiency threshold E_th is determined in the step S540.

In step S570, the control circuit further judges whether all the touched zones are checked or not. If all the touched zones are checked, the control circuit may perform step S580 to report position of each of the touched zones without water ID to the host. On the contrary, if not all the touched zones are checked, the control circuit may go back to perform the step S530 to check next one touched zone.

In this embodiment, the control circuit may report the position of each of the touched zones without water ID to the host. Sush as that, the host can identify the touched zones touched by the finger, and touched position can be obtained by the host precisely.

In this embodiment, the control circuit determines the touched zone is caused by the liquid touch in response to that the control circuit detects the presence of the auxiliary information (the water ID), or determines the touched zone is caused by the liquid touch in response to that the control circuit detects the solar energy conversion efficiency value E of the entire solar panel is not less than a solar energy conversion efficiency threshold E_th even though the control circuit also detects the absence of the water ID.

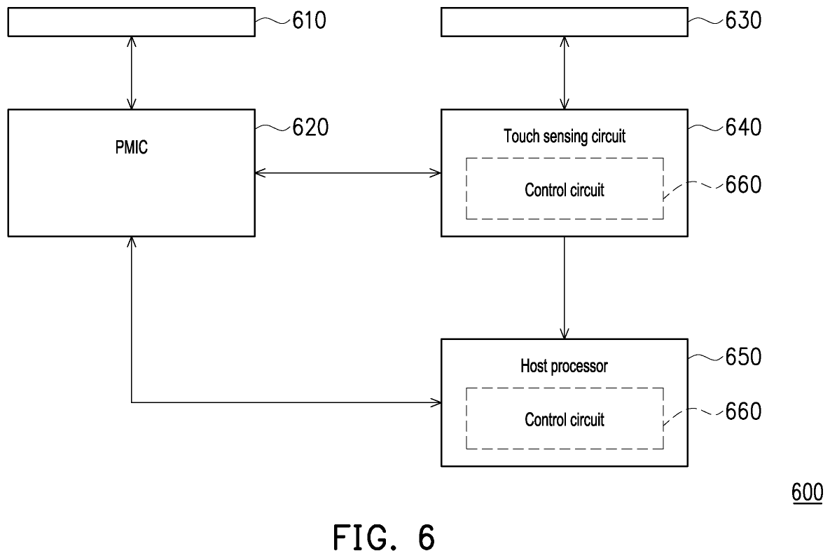

Please refer to FIG. 6, which illustrates an electronic device according to embodiment of present disclosure. The electronic device 600 includes a solar panel 610, a power management integrated circuit (PMIC) 620, a touch panel 630, a touch sensing circuit 640, a host processor 650 and a control circuit 660. The solar panel 610 is used to receive sunlight and is used for converting solar energy of sunlight to generate electricity. The PMIC 620 is coupled to the solar panel 610, and is configured to receive the electricity from the solar panel 610 and generate a solar energy conversion efficiency value representing how much the solar energy is converted to the electricity. The touch panel 630 includes a plurality of touch sensing electrodes. The touch sensing circuit 640 is coupled to the touch panel 630, and the touch sensing circuit 640 may be disposed in a touch sensing integrated circuit, and configured to obtain a plurality of touch sensing signals corresponding to the plurality of touch sensing electrodes from the touch panel 630 and generate a plurality of touch sensing values corresponding to the touch sensing signals by analog-to-digital conversion.

The host processor 650 is coupled to the PMIC 620 and the touch sensing circuit 640. Either the touch sensing circuit 640 or the host processor 650 includes the control circuit 660. The one who has the control circuit 660 is implemented as a touch detection device, and is configure to perform touch detection operation. Detail operations of the control circuit 660 can be seen in previous embodiments mentioned above, and no more repeated descriptions here.

In this embodiment, the control circuit 660 may be a digital circuit, and may be designed through hardware description languages (HDL) or any other design methods for digital circuits familiar to people skilled in the art and may be hardware circuits implemented through a field programmable gate array (FPGA), a complex programmable logic device (CPLD), or an application-specific integrated circuit (ASIC). The host processor 650 may be an application processor (AP).

In addition, if the control circuit 660 is disposed in the touch sensing circuit 640, the solar energy conversion efficiency value may be transmitted to the control circuit 660 which is in the touch sensing circuit 640 from the host processor 650 or the PMIC 620. Moreover, if the control circuit 660 is disposed in the host processor 650, the solar energy conversion efficiency value may be transmitted to the control circuit 660 from the PMIC 650. In this embodiment, the PMIC 620 and the touch sensing circuit 640 may transmit information to each other by parallel interface (such as General-Purpose Input/Output interface, GPIO) or serial interface (such as Inter-Integrated Circuit interface (I²C) or Serial Peripheral Interface Bus (SPI)). The host processor 650 and the touch sensing circuit 640 may also transmit information to each other by parallel interface (such as GPIO) or serial interface (such as I²C or SPI). In one embodiment, the touch sensing circuit 640 may be a touch and display driver integrated circuit (TDDI).

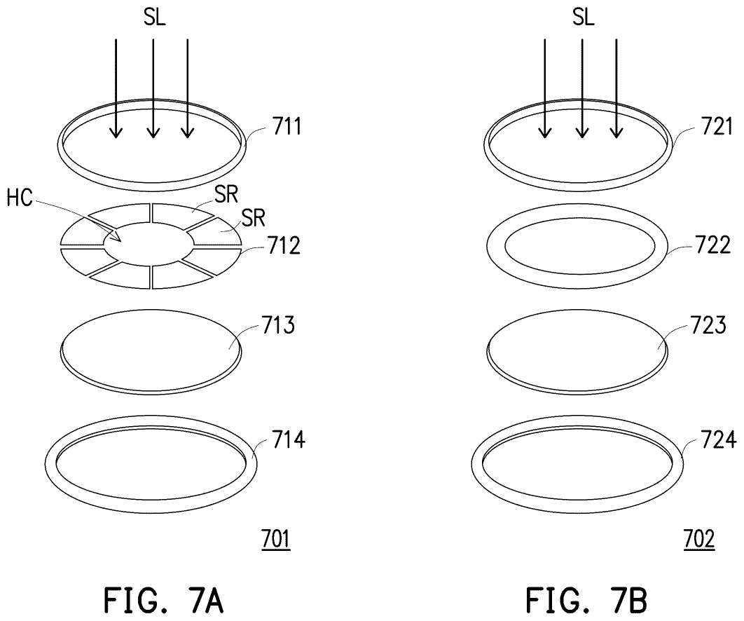

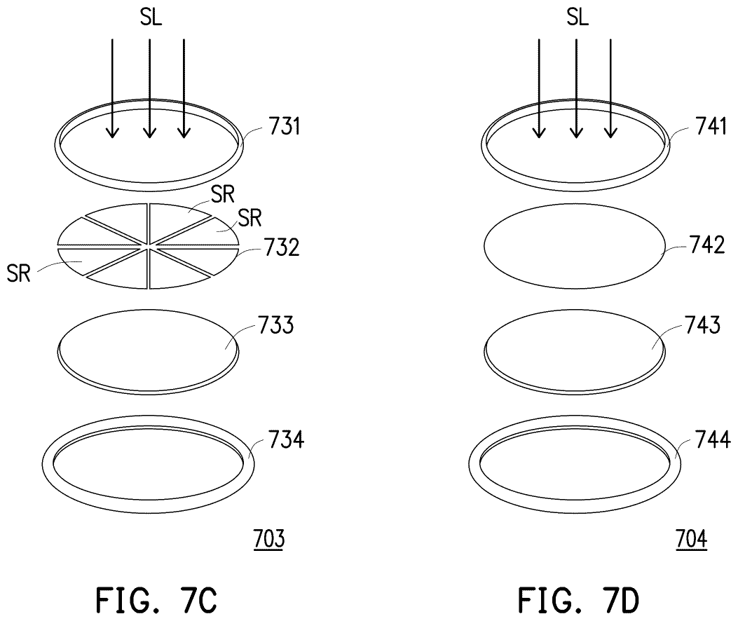

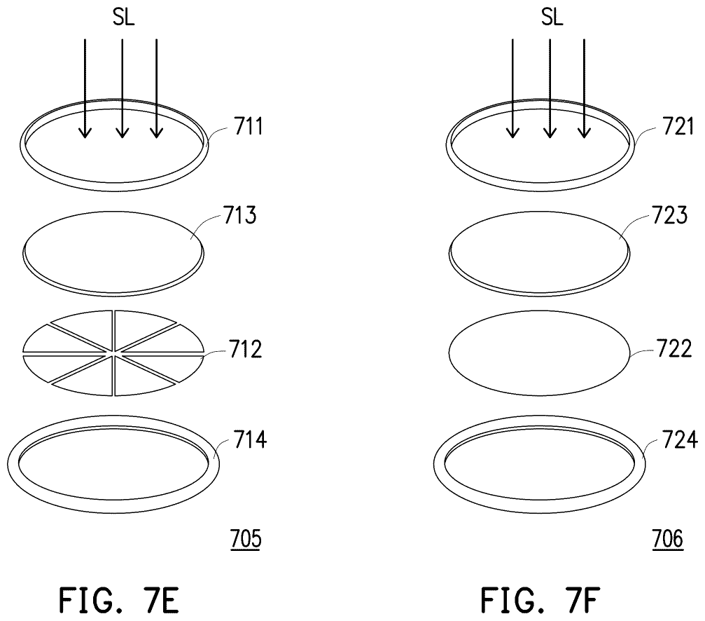

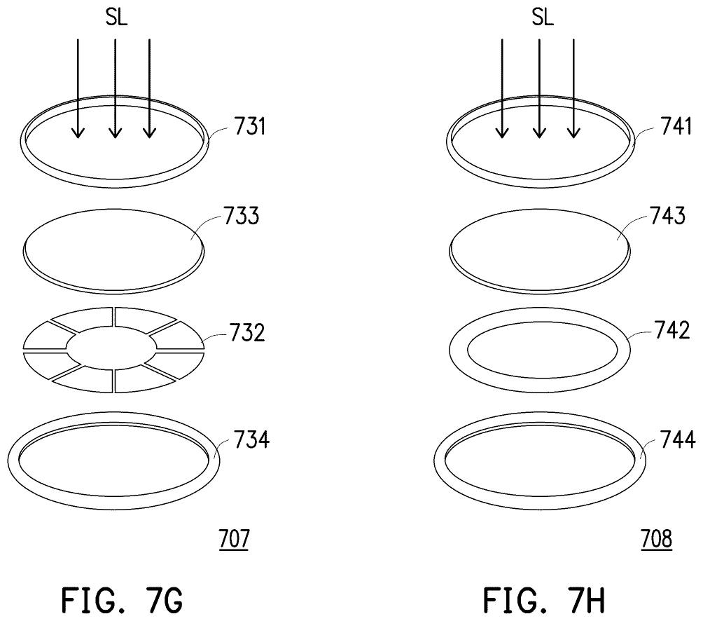

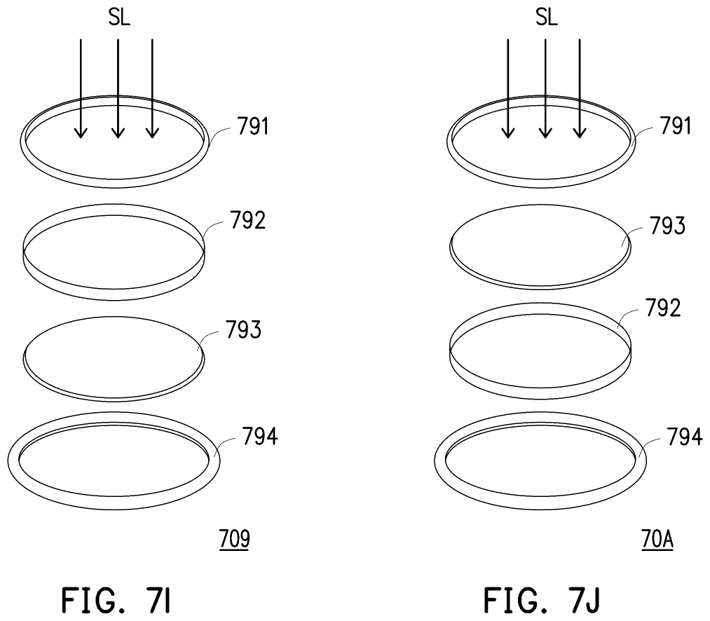

Please refer to FIG. 7A to FIG. 7J, which respectively illustrate a plurality of exploded views of electronic device according to a plurality embodiment of present disclosure. In FIG. 7A, the electronic device 701 includes a cover lens 711 (e.g. cover glass), a solar panel 712, a touch and display panel 713 and a case 714. The cover lens 711, the solar panel 712 and the touch and display panel 713 are overlapped with each other. The cover lens 711 is disposed in a top layer and sunlight SL are transmitted through the cover lens 711 to the solar panel 712. The solar panel 712 may be disposed between the cover lens 711 and the touch and display panel 713. In this embodiment, the solar panel 712 may be an annulus, and may be divided into a plurality of sub-regions SR, and the sub-regions SR surround a hollow center HC.

The touch and display panel 713 is disposed in a bottom layer, and is configured to perform a display operation and a touch detection operation. The touch and display panel 713 may include a display panel and a touch panel which are integrated together with any scheme well known by a person skilled in the art. The cover lens 711, the solar panel 712 and the touch and display panel 713 are assembled into the case 714.

In FIG. 7B, the electronic device 702 includes a cover lens 721, a solar panel 722, a touch and display panel 723 and a case 724. The cover lens 721, the solar panel 722 and the touch and display panel 723 are assembled into the case 724. In this embodiment, the solar panel 722 is disposed above the touch and display panel 723, and the solar panel 722 is an annulus with a larger hollow center than the solar panel 712. Furthermore, the solar panel 722 is not divided into a plurality of sub-regions.

In FIG. 7C, the electronic device 703 includes a cover lens 731, a solar panel 732, a touch and display panel 733 and a case 734. In this embodiment, the solar panel 732 is a solid circle and is divided into a plurality of sub-regions SR. The solar panel 732 is disposed between the cover lens 731 and the touch and display panel 733.

In FIG. 7D, the electronic device 704 includes a cover lens 731, a solar panel 742, a touch and display panel 743 and a case 744. The solar panel 742 is disposed between the cover lens 741 and the touch and display panel 743. In this embodiment, the solar panel 742 is a solid circle and without being divided by sub-regions.

In FIG. 7E, the electronic device 705 includes the cover lens 711, the solar panel 712, the touch and display panel 713 and the case 714. The electronic devices 705 and 701 include same components. Different from the electronic device 701, in the electronic device 705, the touch and display panel 713 is disposed above the solar panel 712.

In FIG. 7F, the electronic device 706 and 702 include the same components, too. Different from the electronic device 702, in the electronic device 706, the touch and display panel 723 is disposed above the solar panel 722.

In FIG. 7G, the electronic device 707 includes same components with the electronic device 703. Different from the electronic device 703, in the electronic device 707, the touch and display panel 733 may be disposed above the solar panel 732.

In FIG. 7H, the electronic device 708 includes same components with the electronic device 704. Different from the electronic device 704, in the electronic device 708, the touch and display panel 743 may be disposed above the solar panel 742.

In FIG. 7I, the electronic device 709 includes a cover lens 791, a solar panel 792, a touch and display panel 793 and a case 794. The cover lens 791, the solar panel 792 and the touch and display panel 793 are overlapped disposed with each other, and are integrated into the case 794. The solar panel 792 is a ring-shape panel, and is disposed above the touch and display panel 793 to surround a top outer profile of the touch and display panel 793.

In FIG. 7J, the electronic device 70A includes same components with the electronic device 709. Different from the e electronic device 709, in the electronic device 70A, the solar panel 792 is disposed under the touch and display panel 793. The solar panel 792 with ring-shape surrounds a bottom outer profile of the touch and display panel 793 It should be noted here, the electronic devices 701 to 70A with circle shape are only illustration examples. The shape of the electronic device of present disclosure may be decided by engineer according to necessary of market without specific limitation.

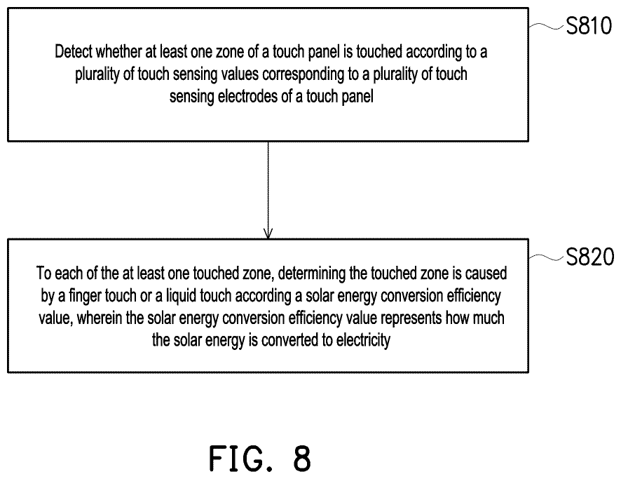

Please refer to FIG. 8, which illustrates a flow chart of a touch detection method according to an embodiment of present disclosure. In step S810, whether at least one zone of a touch panel is touched can be determined according to a plurality of touch sensing values corresponding to a plurality of touch sensing electrodes of a touch panel. In step S820, to each of the at least one touched zone, the touched zone is caused by a finger touch or a liquid touch can be determined according a solar energy conversion efficiency value, wherein the solar energy conversion efficiency value represents how much the solar energy is converted to electricity.

Detail of the steps S810 and S820 have been detailly described in the embodiments above, and no more repeated descriptions here.

In summary, in present disclosure, the touch detection device receives a solar energy conversion efficiency value of a solar panel, and determines each touched zone is caused by finger touch or liquid touch. Such as that, mis-action by the touched zone caused by the liquid touch can be avoided, and accuracy of touch position detected by the touch detection device can be enhanced.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

1. A touch detection device, comprising:
a control circuit, configured to:
detect whether at least one zone of a touch panel is touched according to a plurality of touch sensing values corresponding to a plurality of touch sensing electrodes of the touch panel; and
to each of the at least one touched zone, determine the touched zone is caused by-a a liquid touch according a solar energy conversion efficiency value, wherein the solar energy conversion efficiency value represents how much solar energy is converted to electricity.

2. The touch detection device as claimed in claim 1, wherein the control circuit further determines the touched zone is caused by a finger touch in response to that the control circuit determines the touched zone is in a range of a part of the solar panel which has the solar energy conversion efficiency value less than a first energy conversion efficiency threshold.

3. The touch detection device as claimed in claim 1, wherein the control circuit determines the touched zone is caused by the liquid touch in response to that the control circuit determines the touched zone is not in a range of a part of the solar panel which has the solar energy conversion efficiency value not less than a first energy conversion efficiency threshold.

4. The touch detection device as claimed in claim 1, wherein the control circuit determines the touched zone is caused by a finger touch in response to that the control circuit determines the solar energy conversion efficiency value of a part of the solar panel which position is corresponding to the touched zone is less than a first energy conversion efficiency threshold.

5. The touch detection device as claimed in claim 1, wherein the control circuit determines the touched zone is caused by the liquid touch in response to that the control circuit determines the solar energy conversion efficiency value of a part of the solar panel which position is corresponding to the touched zone is not less than a first energy conversion efficiency threshold.

6. The touch detection device as claimed in claim 1, wherein to each of the at least one touched zone, the control circuit determines the touched zone is caused by a finger touch or the liquid touch according the solar energy conversion efficiency value which is corresponding to the entire solar panel and auxiliary information, wherein the control circuit uses the auxiliary information to identify that the touched zone is caused by the liquid touch or not in a previous touch sensing frame period.

7. The touch detection device as claimed in claim 6, wherein the control circuit determines the touched zone is caused by the liquid touch in response to that the control circuit detects the presence of the auxiliary information, or determines the touched zone is caused by the liquid touch in response to that the control circuit detects the absence of the auxiliary information and also detects the solar energy conversion efficiency value of the entire solar panel which is not less than a first solar energy conversion efficiency threshold.

8. The touch sensing device as claimed in claim 6, wherein the control circuit determines the touched zone is caused by the finger touch in response to that the control circuit detects presence of the auxiliary information, or determines the touched zone is caused by the finger touch in response to that the control circuit detects the absence of the auxiliary information and also detects the solar energy conversion efficiency value of the entire solar panel is less than a first solar energy conversion efficiency threshold.

9. The touch detection device as claimed in claim 1, further comprising:
a touch sensing circuit, configured to obtain the plurality of touch sensing values corresponding to the plurality of touch sensing electrodes of the touch panel and transmit the plurality of touch sensing values to the control circuit.

10. The touch detection device as claimed in claim 1, wherein the solar energy conversion efficiency value is transmitted to the touch detection device from a host processor or a power management integrated circuit, and wherein the power management integrated circuit is coupled to a solar panel for receiving the electricity converted from the solar energy from the solar panel.

11. The touch detection device as claimed in claim 1, wherein the touch detection device receives the plurality of touch sensing values from a touch sensing integrated circuit and receives the solar energy conversion efficiency value from a power management integrated circuit.

12. The touch detection device as claimed in claim 1, wherein the control circuit compares each of the plurality of touch sensing values with a first touch threshold to determine the at least one touched zone.

13. A touch detection method, comprising:
detecting whether at least one zone of a touch panel is touched according to a plurality of touch sensing values corresponding to a plurality of touch sensing electrodes of a touch panel; and
to each of the at least one touched zone, determining the touched zone is caused by liquid touch according a solar energy conversion efficiency value, wherein the solar energy conversion efficiency value represents how much the solar energy is converted to electricity.

14. The touch detection method as claimed in claim 13, further comprising:
determining the touched zone is caused by a finger touch in response to that the touched zone is in a range of a part of the solar panel which has the solar energy conversion efficiency value less than a first energy conversion efficiency threshold has been determined.

15. The touch detection method as claimed in claim 13, further comprising:
determining the touched zone is caused by the liquid touch in response to that the touched zone is not in to a range of a part of the solar panel which has the solar energy conversion efficiency value not less than a first energy conversion efficiency threshold has been determined.

16. The touch detection method as claimed in claim 13, further comprising:
determining the touched zone is caused by a finger touch in response to that the solar energy conversion efficiency value of a part of the solar panel which position is corresponding to the touched zone is less than a first energy conversion efficiency threshold has been determined.

17. The touch detection method as claimed in claim 13, further comprising:
determining the touched zone is caused by the liquid touch in response to that the solar energy conversion efficiency value of a part of the solar panel which position is corresponding to the touched zone is not less than a first energy conversion efficiency threshold has been determined.

18. The touch detection method as claimed in claim 13, further comprising:
to each of the at least one touched zone, determining the touched zone is caused by a finger touch or the liquid touch according the solar energy conversion efficiency value which is corresponding to the entire solar panel and auxiliary information, wherein the auxiliary information is used to identify that the touched zone is caused by the liquid touch or not in a previous touch sensing frame period.

19. The touch detection method as claimed in claim 18, further comprising:
determining the touched zone is caused by the liquid touch in response to that the presence of the auxiliary information is detected, or determining the touched zone is caused by the liquid touch in response to that the absence of the auxiliary information is detected and also the solar energy conversion efficiency value of the entire solar panel which is not less than a first solar energy conversion efficiency threshold is detected.

20. The touch detection method as claimed in claim 18, further comprising:
determining the touched zone is caused by the finger touch in response to that the presence of the auxiliary information is detected, or determining the touched zone is caused by the finger touch in response to that the absence of the auxiliary information is detected and also the solar energy conversion efficiency value of the entire solar panel which is less than a first solar energy conversion efficiency threshold is detected.

21. The touch detection method as claimed in claim 18, further comprising:
obtaining the plurality of touch sensing values corresponding to the plurality of touch sensing electrodes of the touch panel.

22. The touch detection method as claimed in claim 13, further comprising:
receiving the solar energy conversion efficiency value from a host processor or a power management integrated circuit, wherein the power management integrated circuit is coupled to a solar panel for receiving the electricity converted from the solar energy from the solar panel.

23. The touch detection method as claimed in claim 13, further comprising:
receiving the plurality of touch sensing values from a touch sensing integrated circuit and receiving the solar energy conversion efficiency value from a power management integrated circuit.

24. The touch detection method as claimed in claim 13, further comprising:
comparing each of the plurality of touch sensing values with a first touch threshold to determine the at least one touched zone.

25. An electronic device, comprising:
a solar panel for converting solar energy to electricity;
a power management integrated circuit, coupled to the solar panel and configured to receive the electricity converted from the solar energy and generate a solar energy conversion efficiency value representing how much the solar energy is converted to the electricity;
a touch panel comprising a plurality of touch sensing electrodes;
a touch sensing integrated circuit, coupled to the touch panel and configured to obtain a plurality of touch sensing values corresponding to the plurality of touch sensing electrodes; and
a host processor; and
wherein either the touch sensing integrated circuit or the host processor comprises a control circuit, configured to:
detect whether at least one zone of the touch panel is touched according to the plurality of touch sensing values corresponding to the plurality of touch sensing electrodes; and
to each of the at least one touched zone, determine the touched zone is caused by liquid touch according to the solar energy conversion efficiency value.

26. The electronic device as claimed in claim 25, wherein the control circuit further determines the touched zone is caused by a finger touch in response to that the control circuit determines the touched zone is in a range of a part of the solar panel which has the solar energy conversion efficiency value less than a first energy conversion efficiency threshold.

27. The electronic device as claimed in claim 25, wherein the control circuit determines the touched zone is caused by the liquid touch in response to that the control circuit determines the touched zone is not in a range of a part of the solar panel which has the solar energy conversion efficiency value not less than a first energy conversion efficiency threshold.

28. The electronic device as claimed in claim 25, wherein the control circuit determines the touched zone is caused by a finger touch in response to that the control circuit determines the solar energy conversion efficiency value of a part of the solar panel which position is corresponding to the touched zone is less than a first energy conversion efficiency threshold.

29. The electronic device as claimed in claim 25, wherein the control circuit determines the touched zone is caused by the liquid touch in response to that the control circuit determines the solar energy conversion efficiency value of a part of the solar panel which position is corresponding to the touched zone is not less than a first energy conversion efficiency threshold.

30. The electronic device as claimed in claim 25, wherein to each of the at least one touched zone, the control circuit determines the touched zone is caused by a finger touch or the liquid touch according the solar energy conversion efficiency value which is corresponding to the entire solar panel and auxiliary information, wherein the control circuit uses the auxiliary information to identify that the touched zone is caused by the liquid touch or not in a previous touch sensing frame period.

31. The electronic device as claimed in claim 30, wherein the control circuit determines the touched zone is caused by the liquid touch in response to that the control circuit detects the presence of the auxiliary information, or determines the touched zone is caused by the liquid touch in response to that the control circuit detects the absence of the auxiliary information and also detects the solar energy conversion efficiency value of the entire solar panel which is not less than a first solar energy conversion efficiency threshold.

32. The electronic device as claimed in claim 30, wherein the control circuit determines the touched zone is caused by the finger touch in response to that the control circuit detects the presence of the auxiliary information, or determines the touched zone is caused by the finger touch in response to that the control circuit detects the absence of the auxiliary information and also detects the solar energy conversion efficiency value of the entire solar panel is less than a first solar energy conversion efficiency threshold.

33. The electronic device as claimed in claim 25, wherein the touch sensing integrated circuit further comprises a touch sensing circuit, which is configured to obtain the plurality of touch sensing values corresponding to the plurality of touch sensing electrodes of the touch panel and transmit the plurality of touch sensing values to the control circuit.

34. The electronic device as claimed in claim 25, wherein the solar energy conversion efficiency value is transmitted to the control circuit which is in the touch sensing integrated circuit from the host processor or the power management integrated circuit, or the solar energy conversion efficiency value is transmitted to the control circuit which is in the host processor from the power management integrated circuit.

35. The electronic device as claimed in claim 25, wherein the control circuit compares each of the plurality of touch sensing values with a first touch threshold to determine the at least one touched zone.

36. The electronic device as claimed in claim 25, wherein the solar panel is disposed above or below the touch panel, or the solar panel is a ring-shape panel surrounding an outer profile of the touch panel.

37. The electronic device as claimed in claim 25, wherein the shape of the solar panel is a solid circle or an annulus.
